(19) United States
(12) Patent Application Publication
(10) Pub. No.: US 2003/0047564 A1
(43) Pub. Date: Mar. 13, 2003

(54) Insulated container and methods for making and storing the same

(76) Inventor: Charles Veiseh, Los Angeles, CA (US)

Correspondence Address: BRUCE ROSS FERTEL, SUITE 115, 204 SOUTH BEVERLY DRIVE, BEVERLY HILLS, CA, 90212, US

(21) Appl. No.: 09/944,532

(22) Filed: Aug. 31, 2001

(51) Int. Cl. A47J 39/00; A47J 41/00; B65D 81/38; B65D 83/72

(52) U.S. Cl. 220/592.26

(57) ABSTRACT

Improved insulated containers and methods for production and storage are provided. The containers are composed of insulating material and can easily be constructed of a single sheet or a plurality of sheets of insulating material. The containers can be constructed of a flexible insulating material, and if placed inside an outer container, can conform to the contours of the interior surface of the outer container. The containers are thermally insulative and leak-proof, because of the continuous connections that result from the methods of forming the container. The methods of forming the containers also allow for multiple shapes and sizes to be constructed, allowing for placement inside many outer containers that also have varying shapes and sizes. The method of storing the container provides for space efficiency by rolling it into a cylinder.

### FIELD OF THE INVENTION

The present invention relates to the field of insulation for packaging items.

### BACKGROUND OF THE INVENTION

The shipment or transport of perishable items frequently requires that such materials remain at a stable temperature, which is either raised or lowered with respect to ambient temperatures to which the packaging is exposed. Because of long transport times for perishable items and the sensitivity of certain of these items due to slight temperature fluctuations, considerable efforts have been made to provide shipping containers with improved insulating characteristics.

Despite the somewhat satisfactory results of these devices, they have a number of drawbacks. While some of these systems provide arguably comparable insulating results, they frequently are cumbersome, costly, increase the weight of the overall package and decrease the volume of materials that can be transported in a given container. For example, U.S. Pat. No. 5,143,245 to Malone (1992) discloses a leak-proof insulating system for freight containers that requires a plurality of insulative strips for attaching the insulation system to the freight container, an expensive and time consuming procedure.

A number of other known designs have attempted to utilize a bag constructed to nest inside a corresponding corrugated or other outer container. Such bag type constructions have generally not followed the contours of the outer container and have frequently had poor insulating characteristics. As a result, they are generally either too large or too small to be placed inside the outer container. If the bags are significantly smaller than the outer container that they are in, significant packing space is wasted. If the bags are too large, they often bunch up with unwanted excess material at each end, thereby wasting productive packing space and adding packaging weight, which ultimately increases shipping costs. For example, U.S. Pat. No. 5,820,268 to Becker et al. (1998) discloses an insulating bag with a gusseted pouch at either end of the bottom of the bag. Bags having this structure have had problems particularly when a liquid was inside of the bag in providing an adequate moisture-proof seal and preventing spillage. Damage to the outer container and/or the material inside the bags frequently resulted. Attempting to consistently vary the size of such bags to match their contents is again another costly and cumbersome experience. Furthermore, many prior art designs have been designed to perform optimally only when they are not fully loaded with perishable items.

It is therefore apparent that there exists a need in the art for an improved packaging method and apparatus for perishable materials that provides a highly insulative packaging structure that is light weight, less costly for storage and shipping purposes, easily conforms to the shape of an outer shipping container, and has excellent thermal characteristics.

### SUMMARY OF THE INVENTION

The present invention provides an insulated container that is constructed of an insulating material, and includes a bottom with an outer perimeter, and a wall that extends above and is continuously connected to the outer perimeter of the bottom.

The insulated container can be constructed of a single sheet of insulating material or a plurality of such sheets, depending upon the method used for construction. Regardless of the number of sheets used, when connecting the bottom to the wall, or when connecting various segments of the wall to each other, it is preferred that a seal be used. Depending upon the method of construction, the bottom of the insulated container may have numerous shapes, including, but not limited to: a circle, an ellipse, a rectangle, and a hexagon.

The insulated container can also be constructed of a flexible insulating material, such as polyfoam or bubble sheeting, and can be removably inserted into an outer container having an internal surface with contours, such that the insulated container conforms to the contours of the internal surface of the outer container. It is preferred that the insulated container have a metalized surface on either the outer surface of the insulated container, or both the outer surface and the inner surface of the insulated container.

The present invention also provides various methods for constructing the insulated container. One method involves removing segments from opposing ends of a rectangular sheet of insulating material, and then coupling the resultant flaps, preferably by a seal, so as to allow the formation of the wall and the bottom of the insulated container. Another method involves forming a fold within a fold, holding the double folds into place, preferably by a seal, unfolding the inner fold to form the wall and the bottom of the container, and then removing any excess flaps from the insulated container. A third method involves the formation of a cross-shaped piece of insulating material and then coupling the sides of the material together, preferably by a seal, to form the insulated container. A fourth method involves constructing the insulated container from at least two sheets of insulating material.

The present invention further provides a method for storing the insulated container by rolling it into a cylinder having an outer surface, such that a portion of the external surface of the insulated container is on the outer surface of the cylinder.

### BRIEF DESCRIPTION OF THE DRAWING

FIG. 1A shows a cross-sectional view of the layers of a first material used to form the present invention.

FIG. 1B shows a cross-sectional view of the layers of a second material used to form the present invention.

FIG. 2A shows a perspective view of an embodiment of the present invention formed from a single sheet of insulating material.

FIG. 2B shows a top view of the embodiment of the present invention shown in FIG. 2A.

FIGS. 3A, 3B, 3C, and 3D show the steps of forming the embodiment of the present invention of FIGS. 2A and 2B.

FIG. 4 shows a perspective view of an alternative embodiment of the present invention formed from a single sheet of insulating material.

FIG. 5 shows a perspective view of a second alternative embodiment of the present invention formed from a single sheet of insulating material.

FIGS. 6A, 6B, 6C, 6D, and 6E show the steps of forming the embodiment of the present invention of FIG. 5.

FIG. 7A shows a perspective view of a third alternative embodiment of the present invention formed from a single sheet of insulating material.

FIG. 7B shows a top view of the third alternative embodiment of the present invention shown in FIG. 7A.

FIGS. 8A, 8B, and 8C show the steps of forming the embodiment of the present invention of FIGS. 7A and 7B.

FIG. 9A shows a perspective view of an embodiment of the invention formed from a plurality of sheets of insulating material.

FIG. 9B shows a top view of the embodiment of the invention shown in FIG. 9A.

FIG. 10A, 10B, 10C, and 10D show the steps of forming the embodiment of the invention as shown in FIGS. 9A and 9B.

FIG. 11 shows a side view of the storage of an embodiment of the present invention.

### DETAILED DESCRIPTION OF THE INVENTION

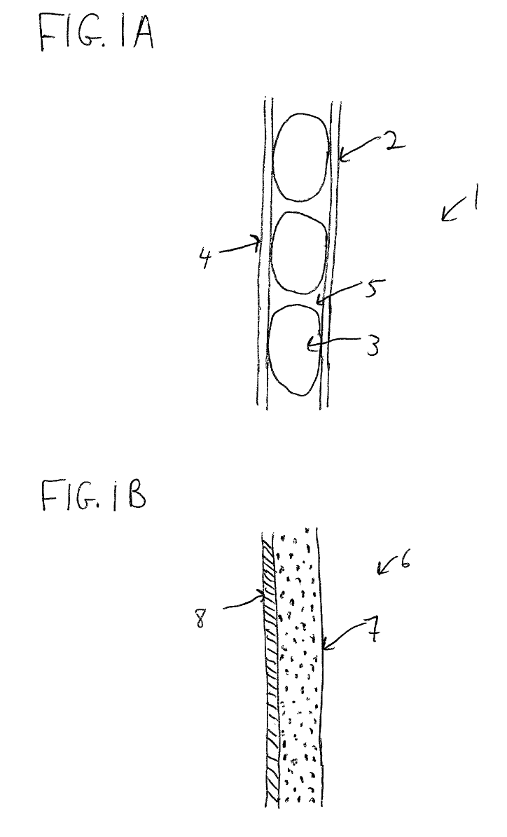

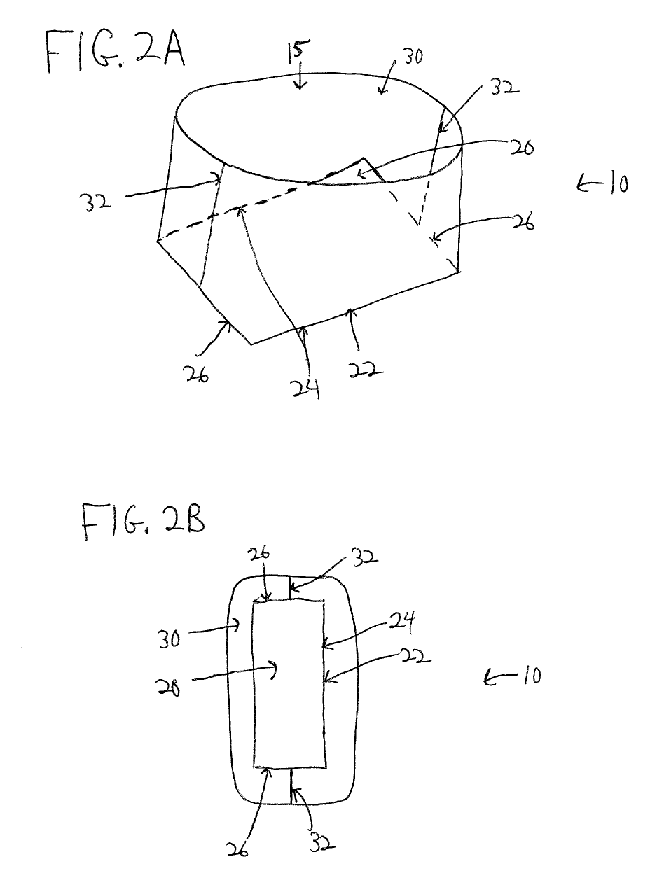

Referring to FIG. 1A and FIG. 1B, the insulated container of the present invention is constructed of a material having a brilliant surface, preferably a metalized polyethylene or metallic foil laminated on one or both of its sides. FIG. 1A illustrates a first preferred material that is a foil laminated bubble sheeting 1. This material has a sidewall constructed of a thin foil laminate 2 such as metalized polyester or polyethylene. The foil laminate 2 is attached to a layer of polyethylene bubble sheeting 3 that has a plastic or polyethylene sidewall 4 opposite the foil laminate 2 and features a number of air pockets 5 within the material. Preferred results have been found when the foil laminate 2 is utilized on either the outer surface of the insulated container, or on both the external surface and the internal surface of the container. A variety of different thicknesses of laminated bubble sheeting 2 may be used depending upon the requirements of the product to be shipped in the container. It has been found that a laminated bubble sheeting having a thickness of 1/2 inch to 3/16 inch has been particularly effective.

Referring now to FIG. 1B, an alternative insulating material for forming the insulated container is illustrated. This alternative material 6 consists of a thickness of polyethylene or polyurethane foam material 7 with a sheet of metalized polyethylene or metallic foil 8 laminated to one side of the foam material 7. The material 6 is preferably used with the metalized polyethylene 8 on either the external surface of the insulated container, or both the external surface and the internal surface of the insulated container. Again, although a variety of thicknesses of polyethylene or polyurethane foam material 7 have been found effective and the given thickness will depend upon the desired properties for any particular shipment, beneficial results have been found with a foam material thickness of as little as 1/8 to 1/4 inch.

In FIGS. 2A and 2B, the insulated container 10 of the present invention is constructed of a flexible insulating material 15, and has a bottom 20 and a wall 30. The bottom 20 has an outer perimeter 22, which defines a boundary between the bottom 20 and the wall 30. The outer perimeter 22 comprises two opposing creases 24 in the insulating material 15, and two opposing horizontal seams 26 bonding the bottom 20 to the wall 30. The wall 30 has two opposing vertical seams 32 beginning from the outer perimeter 22 of the bottom 20 and extending upward. The wall 30 does not have a defined shape, since the flexible insulating material 15 allows the wall 30 to have numerous shapes, and is merely circular in FIG. 2A for illustrative purposes.

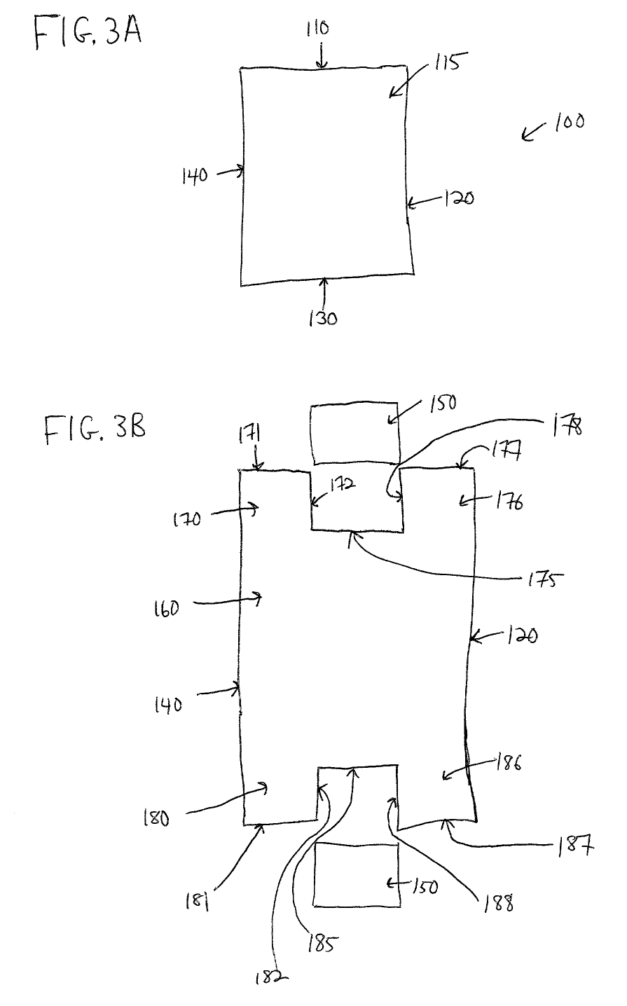

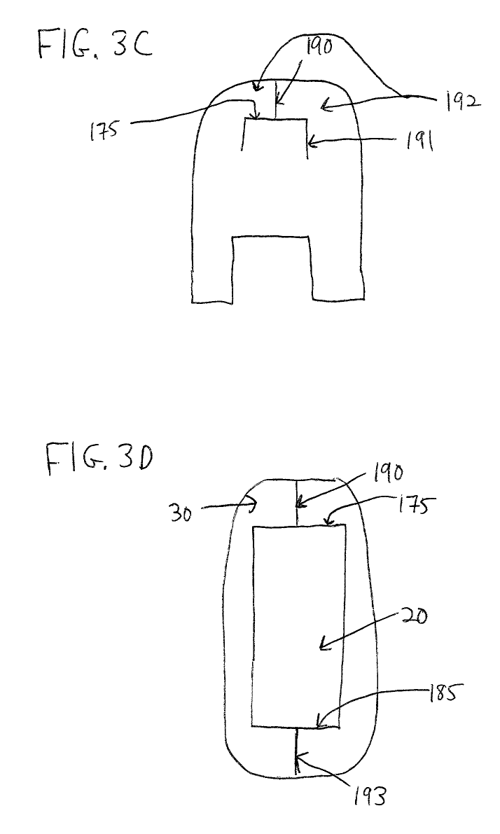

Referring to FIGS. 3A, 3B, and 3C, the insulated container 10 is constructed of a single rectangular sheet 100 of flexible insulating material 15 as shown in FIG. 3A. The single rectangular sheet has a first side 110, a second side 120 adjacent to the first side 110, a third side 130 adjacent to the second side 120 and opposite the first side 110, and a fourth side 140 adjacent to the third side 130 and the first side 110, and opposite to the second side 120. Two smaller rectangular pieces 150 of the single rectangular sheet 100 are then cut out by any known means, thereby forming an H-shaped configuration 160 as shown in FIG. 3B. The H-shaped configuration 160 contains a first flap 170, having an outer end defined by the fourth side 140, an upper end 171, and an inner end 172, a second flap 176, having an outer end defined by the second side 120, an upper end 177, and an inner end 178, a third flap 180 having an outer end defined by the fourth side 140, an upper end 181, and an inner end 182, and a fourth flap 186 having an outer end defined by the second side 120, an upper end 187, and an inner end 188. A first edge 175 separates the first flap 170 with the second flap 176 and a second edge 185 separates the third flap 180 with the fourth flap 186. The first flap 170 and the second flap 176 are then folded towards each other so that the upper end 171 of the first flap 170 and the upper end 177 of the second flap 176 form a first connection 190 as shown in FIG. 3C. The first connection 190 causes the formation of a portion of the wall 192. The portion of the wall 192 is then connected to the first edge 175 to form a portion of the outer perimeter of the bottom 191. In order complete the formation of the insulated container 10, the third flap 180 and the fourth flap 186 are then folded toward each other so that the upper end 181 of the third flap 180 and the upper end 187 of the fourth flap 186 form a second connection 193 as shown in FIG. 3D. The second connection 193 causes the completion of the wall 30 of the insulated container 10. The wall 30 is then connected to the second edge 185 to complete the formation of the bottom 20 of the insulated container 10. The first connection 190, the second connection 193, the first edge 175, and the second edge 185 are then sealed to form a thermally protective and leak-proof barrier as shown by the two opposing horizontal seams 26 and the two opposing vertical seams 32 in FIG. 1B.

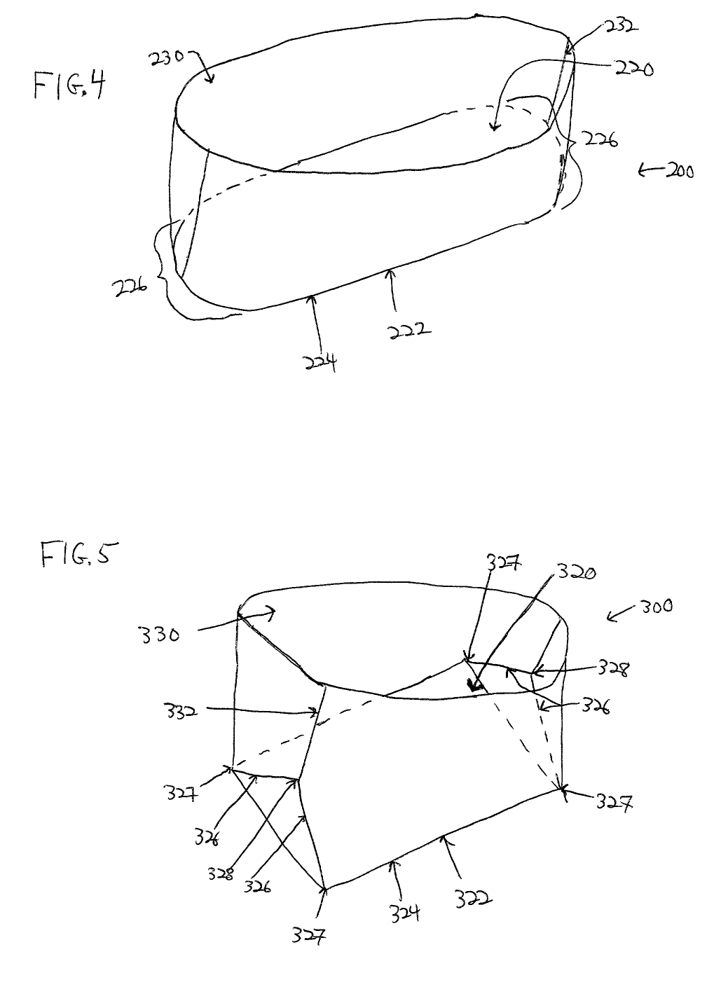

Although the first edge 175 and the second edge 185 in FIG. 3B are straight, it is contemplated that a rectangular sheet of material may be cut to create a plurality of edges facing outward. More edges translate into a container having multiple shapes including, for example, a hexagon formed from three outward edges on each opposing side, or a twelve-sided bottom when each opposing edge has six sides. It is also contemplated that a rectangular sheet of insulating material may be cut to create an outward curved edge, such that an insulated container with a circular bottom is created or an insulated container 200 with an elliptical bottom 220 is created as shown in FIG. 4. As in the insulated container 10 of FIGS. 1A and 1B, the insulated container 200 has a bottom 220 with an outer perimeter 222, a wall 230, two opposing horizontal seams 226, two opposing vertical seams 232, and two opposing creases 224.

In FIG. 5, another embodiment of the invention is represented by the insulated container 300. Here, the bottom 320 has an outer perimeter 322 that is entirely comprised of a i5 crease 324. The wall 330 is attached to the outer perimeter 322 of the bottom 320. The wall 330 has two sets of two diagonal seams 326, each set on opposing sides of the wall 330 and two opposing vertical seams 332 extending upward from an intersection 328 on the wall 330. The diagonal seams 326 each begin at a corner 327 and extend diagonally to the intersection 328 on the wall 330.

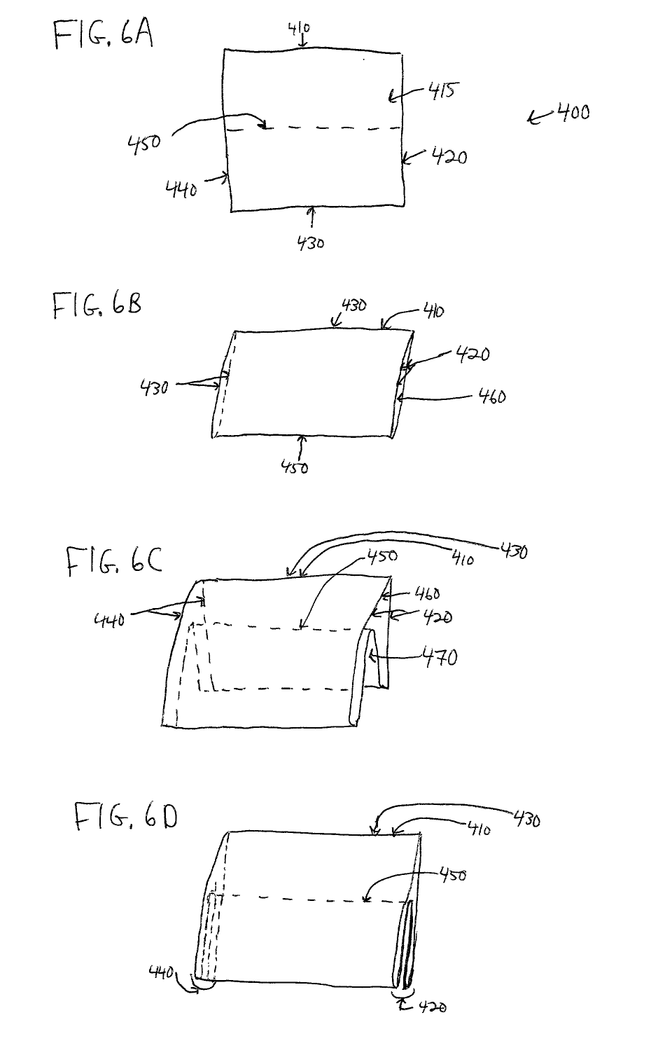

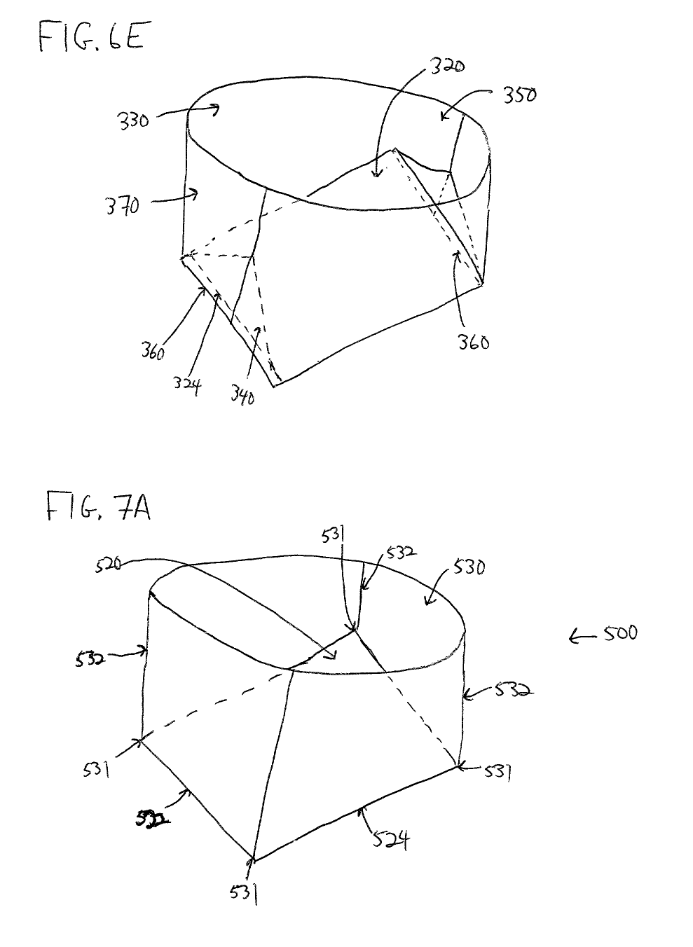

The insulated container 300 is constructed of a single rectangular sheet 400 of flexible insulating material 415 as shown in FIG. 6A. The single rectangular sheet 400 has a first side 410, a second side 420 adjacent to the first side 410, a third side 430 adjacent to the second side 420 and opposite the first side 410, and a fourth side 440 adjacent to the third side 430 and the first side 410, and opposite to the second side 420. The third side 430 is then folded towards the first side 410 along a mid-line 450 of the rectangular sheet 400 to form a first fold 460 such that the first side 410 is coupled to the third side 430 as shown in FIG. 6B. The midline 450 is then folded inward along two opposing sides of the first fold 460 to form a second fold 470 within the first fold 460 as shown in FIG. 6C. The second fold 470 within the first fold 460 is then fastened together, preferably by a seal, along the second side 420 and the fourth side 440 of the rectangular sheet 400 as shown in FIG. 6D. The second fold 470 is then unfolded thereby forming the bottom 320 of the insulated container 300, the wall 330 of the insulated container 300, two opposing inward flaps 340 partially attached to the inner surface 350 of the wall 330, and two opposing outward flaps 360 attached to the outer surface 370 of the wall 330 as shown in FIG. 6E. The two opposing inward flaps 340 are then fastened, preferably by a seal, to the wall 330, and the two opposing outward flaps 360 are removed from the wall 330, by any known means, forming the insulated container 300 of FIG. 5.

In FIGS. 7A and 7B, another embodiment of the present invention is represented by the insulated container 500. Here, the bottom 520 has an outer perimeter 522 that is entirely comprised of a crease 524. The wall 530 is attached to the outer perimeter 522 of the bottom 520 and has four vertical seams 532, each seam extending from a corner 531 of the bottom 520 of the insulated container 500.

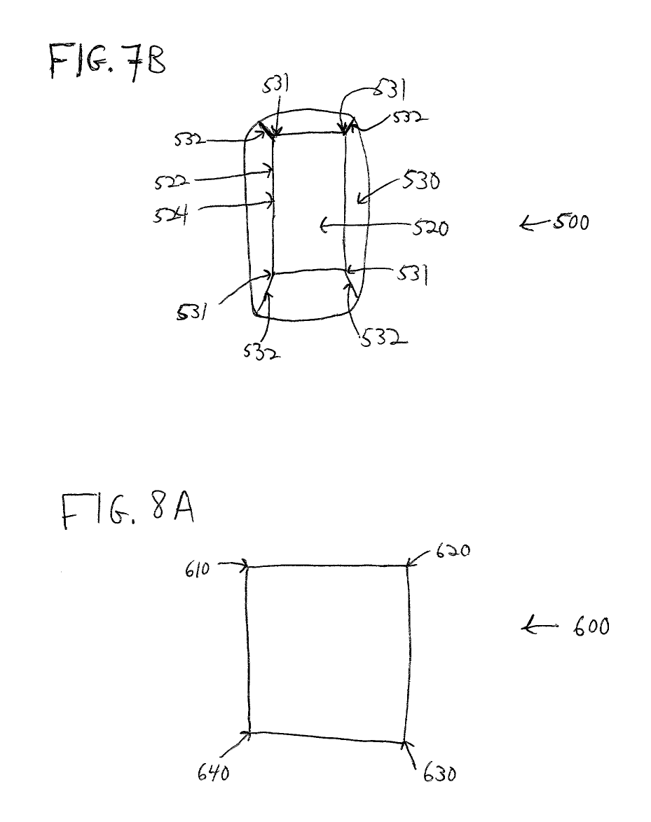

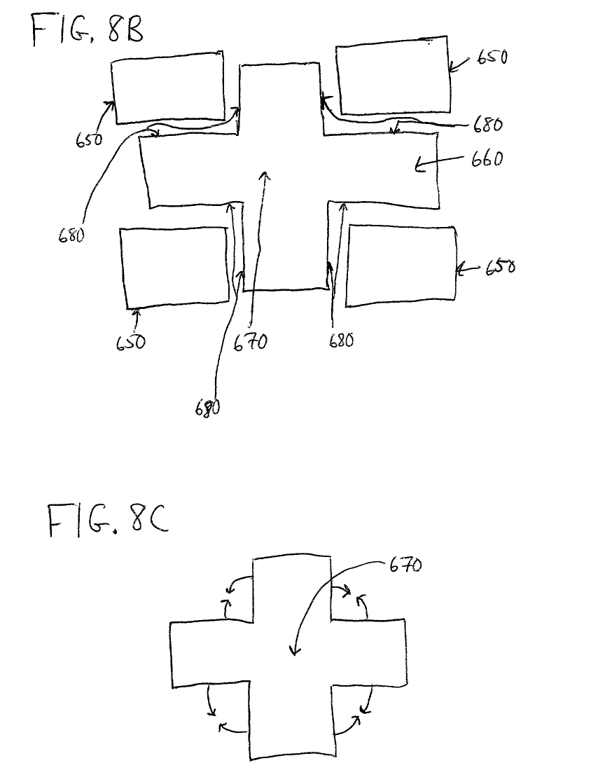

The insulated container 500 is constructed of a single rectangular sheet 600 of flexible insulating material 615 as shown in FIG. 8A. The single rectangular sheet 600 has a first corner 610, a second corner 620, a third corner 630, and a fourth corner 640. A rectangular portion 650 of the single rectangular sheet 600 is removed from each of the four corners 610, 620, 630, and 640, thereby forming a cross-shaped piece of insulating material 660 having a center 670 and four sets of two adjacent perpendicular sides 680 as shown in FIG. 8B. Each of the two adjacent, perpendicular sides 680 of the cross-shaped piece of insulating material 660 are then folded together as shown by the four sets of double arrows in FIG. 8C. The two adjacent, perpendicular sides 680 are fastened, preferably by a seal, thereby forming the wall 530 of the insulated container 500, wherein the center 670 of the cross-shaped piece of insulating material 660 becomes the bottom 520 of the insulated container 500 as shown in FIGS. 7A and 7B.

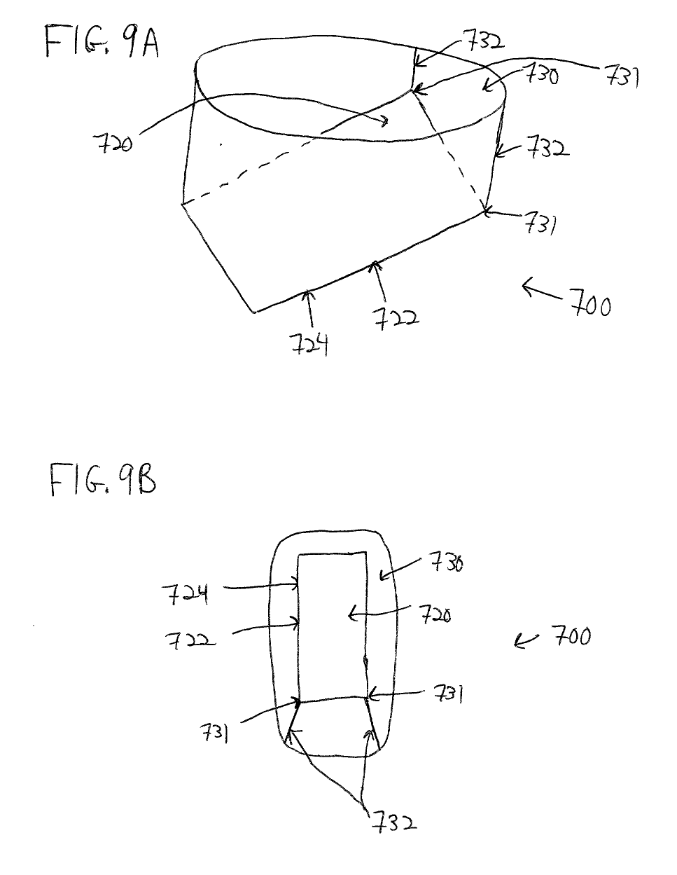

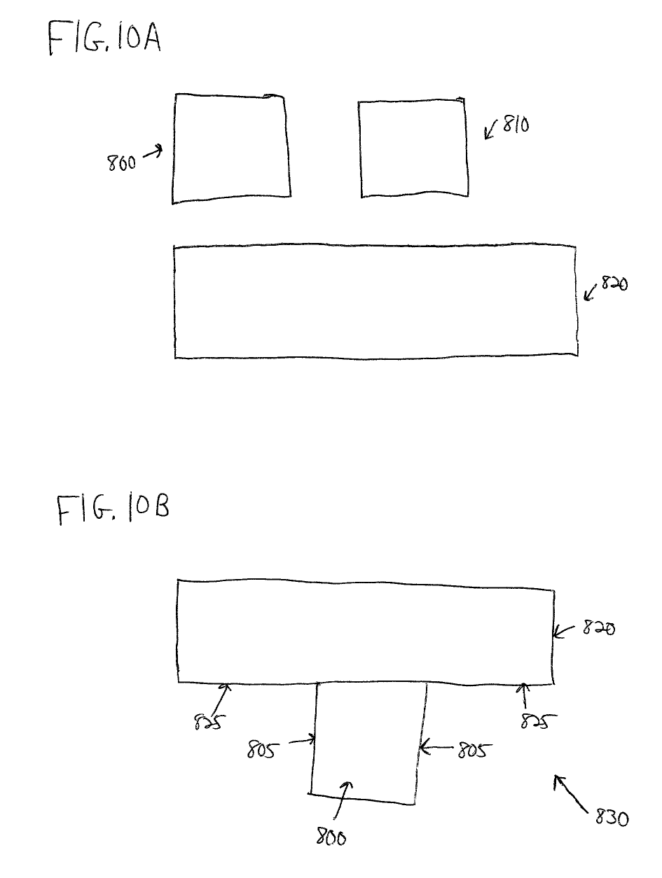

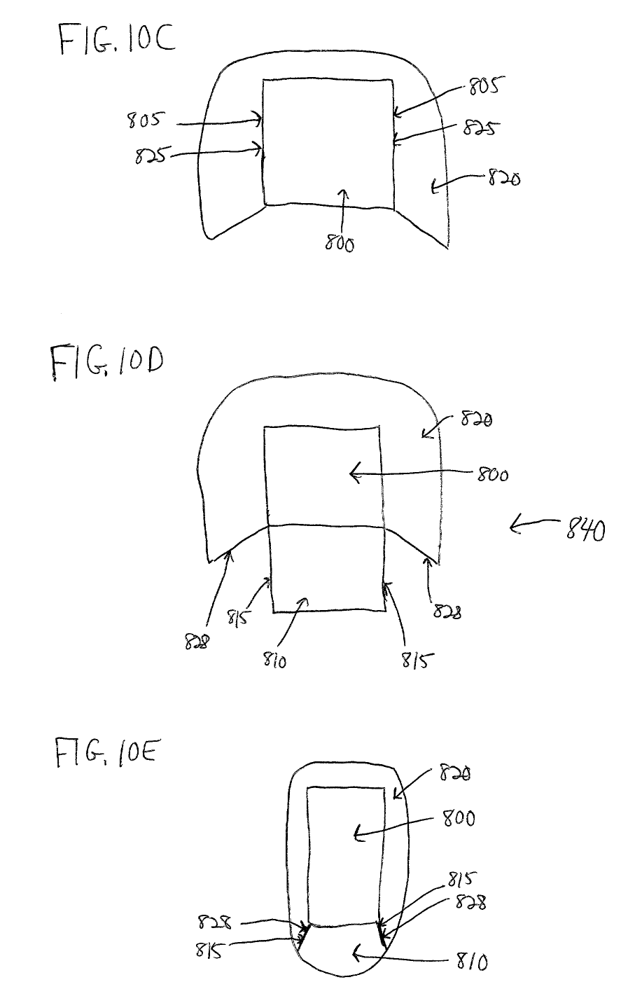

In FIGS. 9A and 9B, an embodiment of the present invention represented by the insulated container 700 is created by a plurality of insulating walls. Here, the bottom 720 has an outer perimeter 722 that is entirely comprised of a seam 724. The wall 730 is attached to the outer perimeter 722 of the bottom 720 and has two vertical seams 732 each seam extending from two adjacent corners 731 of the bottom 720 of the insulated container 700.

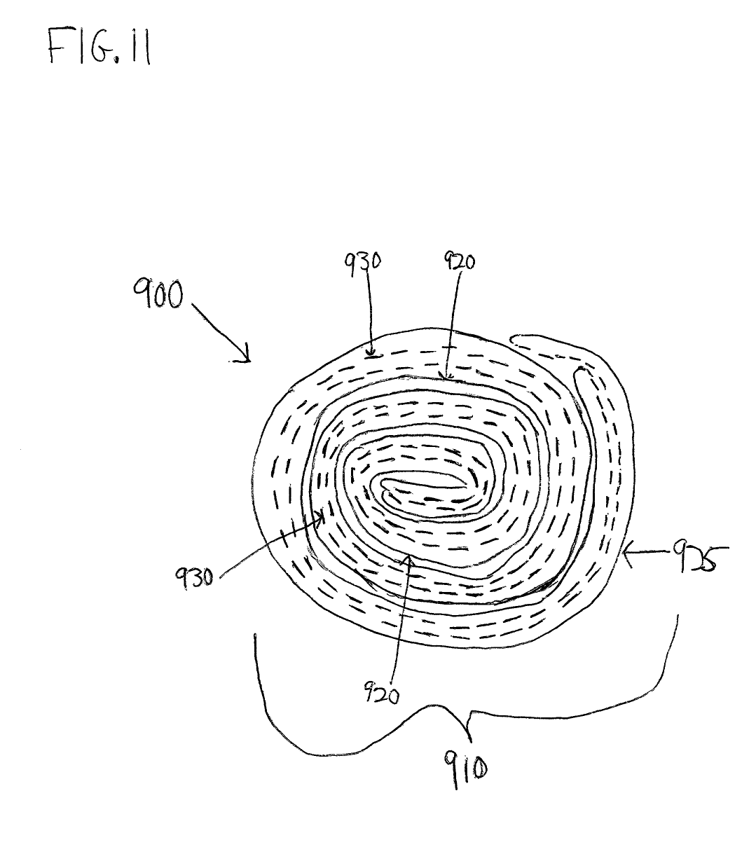

As shown in FIG. 10A, the insulated container 700 is constructed of three pieces of rectangular insulating material: a first piece 800, a second piece 810, each piece having equal dimensions, and a third piece 820 of rectangular material having a side that is three times the length of one of the sides of the first piece 800 and the second piece 810. The first piece 800 is then fastened to the third piece 820, preferably by a seal, to form a T-shaped configuration 830 as shown in FIG. 10B, such that the length of two adjacent sides 805 to the attached side of the first piece 800 is equal to two unattached portions 825 of the attached side of the third piece 820. Each of the two adjacent sides 805 of the first piece 800 is then attached to each of the two unattached portions 825 of the attached side of the third piece 820, such that the first piece 800 forms the bottom 720 of the insulated container 700, and the third piece 820 form a portion of the wall 730 as shown in FIG. 10C. The second piece 810 is then fastened to an unattached side of the first piece 800, preferably by a seal, to form another T-shaped configuration 840 as shown in FIG. 10D, such that the length of two adjacent sides 815 of the attached side of the second piece 810 is equal to two unattached portions 828 of the third piece 820. Each of the two adjacent sides 815 of the second piece 810 is then attached to each of the two unattached sides 828 of the third piece 820 as shown in FIG. 10E, such that the second piece 810 completes the formation of the wall 730 of the insulated container 700.

In FIG. 11, the insulated container 900, which has an external surface 920 and an internal surface 930, is stored as a cylinder 910. The cylinder 910 is rolled in a manner so that a portion of the external surface 920 of the insulated container 900 forms an outer surface 925 of the cylinder 900.

It is also contemplated that the insulated container of the present invention will be closed if placed inside an outer container. Since the insulated container is contemplated to be composed of flexible insulating material, the means of closing the insulated container will depend upon the shape of the wall and the bottom of the insulated container, as well as the shape of the inner surface of the outer container. Any known means of closing the insulated container may be performed to complete the storage process.

### EXAMPLES

A series of tests were performed in order to analyze the performance of the present invention with other insulating containers under various conditions. Characteristics of the insulating containers that were tested include: 1) space efficiency and 2) insulative properties.

Space Efficiency

Referring to Table 1, two containers were compared for space efficiency. A one-inch thick piece of insulating material was used to construct the container of the present invention and the interior volume of the container, and when placed inside a 12-inch by 10-inch by 3-inch outer container, was 80 cubic inches. When a container constructed with identical material and having identical dimensions, but with a gusseted extension at either end of the container was placed into the same outer container, the interior volume of the container was reduced to 48 cubic inches. Using the container of the present invention increases the available interior volume by 66% because the gusseted extensions form a 3-ply layer at either end, displacing available space that can be used to store items for transport or shipment.

TABLE 1

| TYPE OF | Available interior space in container when placed |
|---|---|
| CONTAINER | into a 12-inch by 10-inch by 3-inch outer container |
| Present invention | 80 cubic inches |
| Gusseted container | 48 cubic inches |

Insulative Properties

In a first test, a container of the present invention was completely filled with water. The container remained leak-proof. A container having a gusseted extension at either end of the container was also filled completely with water. The gusseted extension detached within 30 minutes from the side of the container, forming a rectangular pouch, after which the water leaked out of the container.

In a second test, the container of the present invention and the container having a gusseted extension at either end of the container were each filled with 30 pounds of fish, stored for 12 hours and moved regularly. After drying for a period of 24 hours, the container having the gusseted extensions produced a strong odor of fish, emanating directly from the gusseted ends, even after drying. After another 12 hours passed, the fish odor was even stronger. The pouches at either end of the gusseted extensions allowed liquids to enter, thereby reducing accessibility to the container for cleaning. The residue left in the pouches provided for bacterial growth as evidenced by the odor. The container of the present invention produced no such odor and was ready for reuse after the drying period.

In a third test, thermal insulative properties of the present invention were compared to other containers by placing each container into a corrugated outer container. The first container was 6 sheets of expanded polystryene (foam EPS) lined to the corrugated outer container and the second container was a molded EPS container. A temperature of 35° F. was initiated inside each of the three containers with the aid of frozen refrigerant gel packs. As illustrated in Table 2, when comparing the present invention with the 6 sheets of foam EPS, the foam EPS maintained the temperature of 35° F. for 13 hours, while the present invention maintained the same temperature for a 45% longer period of time at 18 hours and 51 minutes. When comparing the present invention with the molded EPS containers, the molded EPS containers maintained the temperature of 35° F. for 14 hours, while the present invention maintained the same temperature for a 40% longer period of time at 19 hours and 36 minutes.

TABLE 2

| | Time of temperature | Time of temperature |
|---|---|---|
| TYPE OF | maintenance at 35° F. | maintenance at 35° F. |
| CONTAINER | (Comparison 1) | (Comparison 2) |
| Present Invention | 18 hours and 51 minutes | 19 hours and 36 minutes |
| 6 Sheets of Foam | 13 hours | — |
| EPS | | |
| Molded EPS | — | 14 hours |

From these examples, it is clear that the present invention was demonstrated to produce more effective results in its use than other containers.

Thus, while specific embodiments and applications of this invention have been shown and described, it would be apparent to those skilled in the art that many more modifications are possible without departing from the inventive concepts herein. The invention, therefore, is not to be restricted except in the spirit of the appended claims.

1. A container having an internal surface and an external surface, comprising:
a bottom having an outer perimeter; and
a wall having an outer surface and an inner surface,
wherein the wall extends above and has a continuous connection to the outer perimeter of the bottom, and wherein the bottom and the wall are constructed of an insulating material.

2. The container of claim 1, wherein the outer perimeter of the bottom has a curved edge.

3. The container of claim 2, wherein the outer perimeter of the bottom has a shape selected from the group consisting of: a circular shape and an elliptical shape.

4. The container of claim 1, wherein the outer perimeter of the bottom has a straight edge.

5. The container of claim 1, wherein the outer perimeter of the bottom has a plurality of straight edges.

6. The container of claim 1, wherein the insulating material comprises a single sheet.

7. The container of claim 1, wherein the insulating material comprises a plurality of sheets.

8. The container of claim 1, wherein the insulating material comprises a flexible insulating material.

9. The container of claim 8, wherein the container is removably inserted into an outer container having an interior surface with contours, and the container conforms to the contours of the interior surface of the outer container.

10. The container of claim 1, wherein the insulating material is selected from the group consisting of: polyfoam and bubble sheeting.

11. The container of claim 1, wherein the insulating material has a metalized surface on the outer surface of the container.

12. The container of claim 1, wherein the insulating material has a metalized surface on the outer surface and the inner surface of the container.

13. The container of claim 1, wherein the continuous connection is selected from the group consisting of: a crease and a seam.

14. A method of forming the container of claim 6, comprising the steps of:
providing a rectangular sheet of insulating material having a first side and a second side, opposing the first side;
removing a first section of the rectangular sheet from the first side to form a first flap having an inner end and an upper end, a second flap having an inner end and an upper end, and a first edge separating the first flap and the second flap;
removing a second section of the rectangular sheet from the second side to form a third flap having an inner end and an upper end, a fourth flap having an inner end and an upper end, and a second edge separating the third flap and the fourth flap;
coupling the upper end of the first flap to the upper end of the second flap to form a first connection, thereby forming a first portion of the wall of the container;
coupling the inner end of the first flap and the inner end of the second flap to the first edge to form a second connection such that the first edge forms a first portion of the outer perimeter of the bottom of the container;
coupling the upper end of the third flap to the upper end of the fourth flap to form a third connection, thereby forming a second portion of the wall of the container; and
coupling the inner end of the third flap and the inner end of the fourth flap to the second edge to form a fourth connection such that the second edge forms a second portion of the bottom of the container.

15. The method of claim 14, further comprising the step of sealing: i) the first connection, ii) the second connection, iii) the third connection, and iv) the fourth connection.

16. The method of claim 14, wherein the first edge and the second edge are selected from the group consisting of: a curved edge, a straight edge, and a plurality of straight edges.

17. A method of forming the container of claim 6, comprising the steps of:
providing a rectangular sheet of insulating material having a first side, a second side adjacent to the first side, a third side adjacent to the second side and opposite the first side, and a fourth side adjacent to the third side and the first side, and opposite to the second side;
folding the third side towards the first side along a mid-line of the rectangular piece to form a first fold such that the first side is coupled to the third side;
folding the mid-line inward along two opposing sides of the first fold to form a second fold within the first fold;
fastening the second fold within the first fold along the second side of the rectangular sheet;
fastening the second fold within the first fold along the fourth side of the rectangular sheet;
unfolding the second fold, thereby forming the bottom of the container, the wall of the container, two opposing inward flaps partially attached to the inner surface of the wall, and two opposing outward flaps attached to the outer surface of the wall;
fastening the two opposing inward flaps to the wall; and
removing the two opposing outward flaps from the wall.

18. The method of claim 17, wherein the steps of fastening the second fold within the first fold and fastening the two opposing inward flaps to the wall are achieved by a seal.

19. A method of forming the container of claim 6, comprising the steps of:
providing a rectangular sheet of insulating material having a first corner, a second corner a third corner, and a fourth corner;
removing four rectangular portions of the rectangular sheet, each of the four rectangular portions from the first corner, the second corner, the third corner, and the fourth corner, respectively, thereby forming a cross-shaped piece of insulating material having a center and four sets of two adjacent perpendicular sides; and
fastening each of the two adjacent perpendicular sides of the cross-shaped piece of insulating material, thereby forming the wall of the container, wherein the center of the cross-shaped piece of insulating material forms the bottom of the container.

20. A method of forming the container of claim 7, comprising the steps of:
providing at least two sheets of insulating material;
fastening the at least two sheets of insulating material to form the container.

21. A method of storing the container of claim 1, comprising the steps of:
providing the container;
rolling the container into a cylinder having an outer surface, such that a portion of the external surface of the container is on the outer surface of the cylinder.
